(19) United States
(12) Patent Application Publication
(10) Pub. No.: US 2026/0341776 A1
(43) Pub. Date: Oct. 29, 2026

(54) ELECTRODE STACK

(71) Applicant: TOYOTA JIDOSHA KABUSHIKI KAISHA, Toyota-shi (JP)

(72) Inventors: Suguru IKEYAMA, Toyota-shi (JP); Yosuke Shimura, Nagakute-shi (JP); Yasuhiro Sakashita, Nissin-shi (JP); Tomofumi HIrukawa, Miyoshi-shi (JP); Kazuhito Kato, Toyota-shi (JP); Takahiko Nakano, Nagoya-shi (JP)

(73) Assignee: TOYOTA JIDOSHA KABUSHIKI KAISHA, Toyota-shi (JP)

(21) Appl. No.: 19/541,672

(22) Filed: Feb. 17, 2026

(30) Foreign Application Priority Data
Apr. 25, 2025 (JP) 2025-073691

(51) Int. Cl. H01M 10/0525; H01M 4/131; H01M 10/04; H01M 10/052; H01M 10/0585

(52) U.S. Cl. CPC H01M 10/0525; H01M 4/131; H01M 10/0431; H01M 10/052; H01M 10/0585

(57) ABSTRACT

The electrode stack includes: a plurality of electrode sheets stacked along a first direction; and an elongated separator extending in a zigzag manner between the electrode sheets. Each of the electrode sheets includes a current collector foil and an electrode active material layer provided on one surface of the current collector foil. In at least one of the electrode sheets, at least one protective member extending along the outer edge of the electrode active material layer is provided on either or both of the electrode sheet and the separator. The outer edge of the electrode active material layer has a shape having at least one corner. Each of the at least one protective member extends, at any one of the at least one corner, along two sides that define the corner.

### CROSS-REFERENCE TO RELATED APPLICATION

This application claims priority to Japanese Patent Application No. 2025-073691 filed on Apr. 25, 2025. The disclosure of the above-identified application, including the specification, drawings, and claims, is incorporated by reference herein in its entirety.

### BACKGROUND

### 1. Technical Field

The technology disclosed in the present specification relates to electrode stacks.

### 2. Description of Related Art

Japanese Unexamined Patent Application Publication No. 2009-218105 (JP 2009-218105 A) describes an electrode stack. The electrode stack includes a plurality of electrode sheets stacked on each other, and an elongated separator that extends in a zigzag manner between the electrode sheets. Each of the electrode sheets includes a current collector foil and an electrode active material layer provided on one surface of the current collector foil.

### SUMMARY

In an electrode stack such as the one described above, the outer edge of the electrode active material layer may have a shape having at least one corner (for example, a rectangular shape). Since the electrode active material layer has relatively high rigidity, there is a risk that a corner of the electrode active material layer may come into contact with another member, such as an exterior member that houses the electrode stack or a separator that extends between the electrode sheets and may damage the other member.

In view of the above circumstances, the present specification provides a technology for reducing the likelihood that a corner of an electrode active material layer causes damage to another member.

The technology disclosed in the present specification is embodied in an electrode stack. According to a first aspect, an electrode stack includes: a plurality of electrode sheets stacked along a first direction; and a separator that is elongated and extends in a zigzag manner between the electrode sheets. Each of the electrode sheets includes a current collector foil and an electrode active material layer provided on one surface of the current collector foil. In at least one of the electrode sheets, at least one protective member that extends along an outer edge of the electrode active material layer is provided on either or both of the electrode sheet and the separator. The outer edge of the electrode active material layer has a shape having at least one corner. Each of the at least one protective member extends, at any one of the at least one corner, along two sides that define the corner.

In the electrode stack described above, at a corner of the electrode active material layer, the protective member extends along the two sides that define that corner. With this configuration, since the protective member is interposed between the corner of the electrode active material layer and another member, the electrode active material layer is less likely to cause damage to the other member.

According to a second aspect, in the first aspect, the outer edge of the electrode active material layer may have a rectangular shape having four corners. In this case, the at least one protective member may include four protective members respectively disposed at the four corners. With such a configuration, at each of the four corners of the electrode active material layer, a protective member can be interposed between the corner of the electrode active material layer and another member.

According to a third aspect, in the first or second aspect, the at least one protective member may include an annular protective member that extends along the entirety of the outer edge of the electrode active material layer. With such a configuration, a protective member can be interposed between the electrode active material layer and another member over the entirety of the outer edge of the electrode active material layer.

According to a fourth aspect, in any one of the first to third aspects, the electrode sheets may include a first electrode sheet and a second electrode sheet. In this case, the first electrode sheet may include, as the electrode active material layer, a first electrode active material layer. The second electrode sheet may include, as the electrode active material layer, a second electrode active material layer that faces the first electrode active material layer via the separator. At least one first protective member that extends along an outer edge of the first electrode active material layer may be provided on either or both of the first electrode sheet and the separator. At least one second protective member that extends along an outer edge of the second electrode active material layer may be provided on either or both of the second electrode sheet and the separator. When viewed along the first direction, the position of the outer edge of the first electrode active material layer may be different from the position of the outer edge of the second electrode active material layer, while the position of the at least one first protective member may coincide with the position of the at least one second protective member. With such a configuration, unintended bends or wrinkles are less likely to be formed in the current collector foil(s) and/or the separator.

According to a fifth aspect, in any one of the first to fourth aspects, the at least one protective member may be provided for the electrode active material layer of at least the electrode sheet that is located at one end in the first direction among the electrode sheets. The electrode active material layer of the electrode sheet located at one end in the first direction is considered to have a higher risk of damaging another member than the electrode active material layer of an electrode sheet located inside. Therefore, with the configuration described above, it is possible to reduce the likelihood that the electrode active material layer causes damage to another member, while reducing the number of electrode active material layers for which a protective member is provided.

According to a sixth aspect, in any one of the first to fifth aspects, the at least one protective member may be provided for each of the electrode sheets. With such a configuration, it is possible to more reliably reduce the likelihood that the electrode active material layer causes damage to another member.

According to a seventh aspect, in any one of the first to sixth aspects, the at least one protective member may be formed of a sheet member made of the same material as the separator. With such a configuration, the protective member can be formed of, for example, the sheet member provided on the separator.

According to an eighth aspect, in any one of the first to sixth aspects, the at least one protective member may be formed of a member different from the separator.

According to a ninth aspect, in any one of the first to eighth aspects, the dimension of the at least one protective member in the first direction is less than or equal to the dimension, in the first direction, of the electrode active material layer provided on the at least one of the electrode sheets. With such a configuration, a gap is less likely to be formed between the electrode active material layer and the separator in the first direction.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing the configuration of a battery 100;

FIG. 2 is a diagram illustrating that an electrode stack 10 is housed inside an exterior member 102;

FIG. 3 is a diagram schematically showing the configuration of the electrode stack 10 according to an embodiment;

FIG. 4A is an enlarged view of a portion IV(A) in FIG. 3;

FIG. 4B is an enlarged view of a portion IV(B) in FIG. 3;

FIG. 5 is a schematic view of the electrode stack 10 when viewed along the Z-direction;

FIG. 6 is a sectional view taken along line VI-VI in FIG. 5;

FIG. 7A is a diagram showing a first upper protective member 50a of the embodiment when viewed along the Z-direction;

FIG. 7B is a diagram showing the first upper protective member 50a of another modification when viewed along the Z-direction;

FIG. 7C is a diagram showing the first upper protective member 50a of still another modification when viewed along the Z-direction;

FIG. 7D is a diagram showing the first upper protective member 50a of yet another modification when viewed along the Z-direction; and

FIG. 8 is a sectional view corresponding to FIG. 6, illustrating a modification.

### DETAILED DESCRIPTION OF EMBODIMENTS

An electrode stack 10 according to an embodiment and a battery 100 employing the electrode stack 10 will be described. The battery 100 is, for example, a lithium-ion secondary battery. The battery 100 has a rectangular, flat plate shape. In the following description, the thickness direction of the battery 100 is referred to as the Z- direction, the longitudinal direction of the battery 100 as the X-direction, and the direction orthogonal to both the Z- and X-directions as the Y-direction.

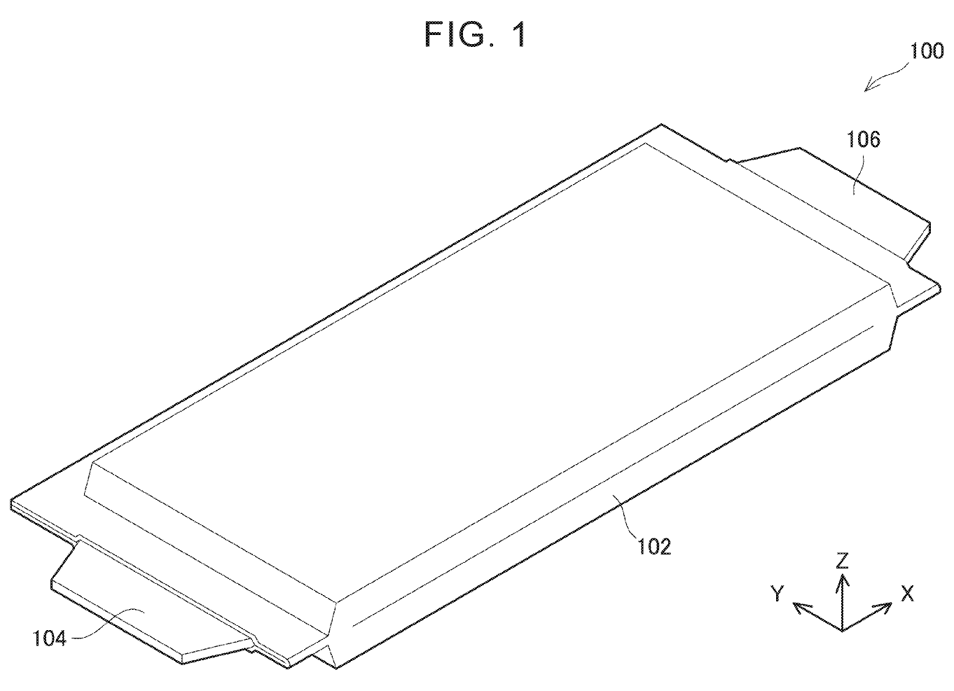

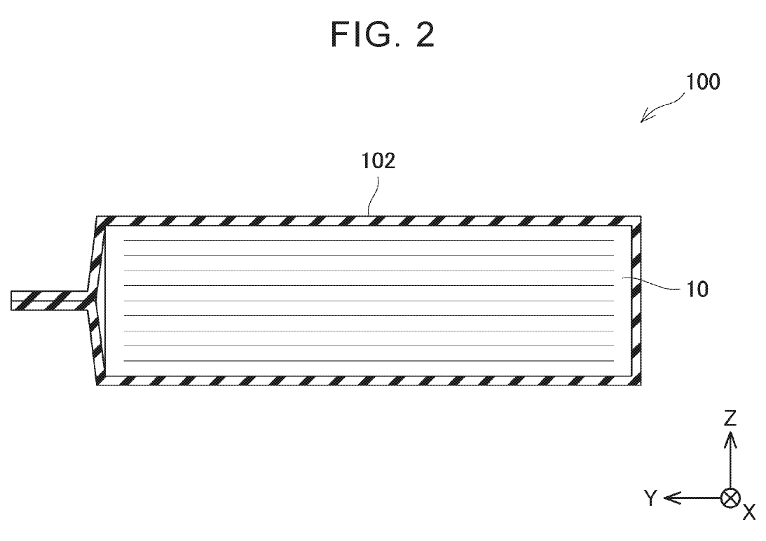

As shown in FIGS. 1 and 2, the battery 100 includes an exterior member 102. The electrode stack 10 is sealed in the exterior member 102 together with an electrolytic solution (not shown). The exterior member 102 is formed of a thin film. For example, the exterior member 102 may be a laminate film in which resin coating films are provided on both surfaces of an aluminum foil.

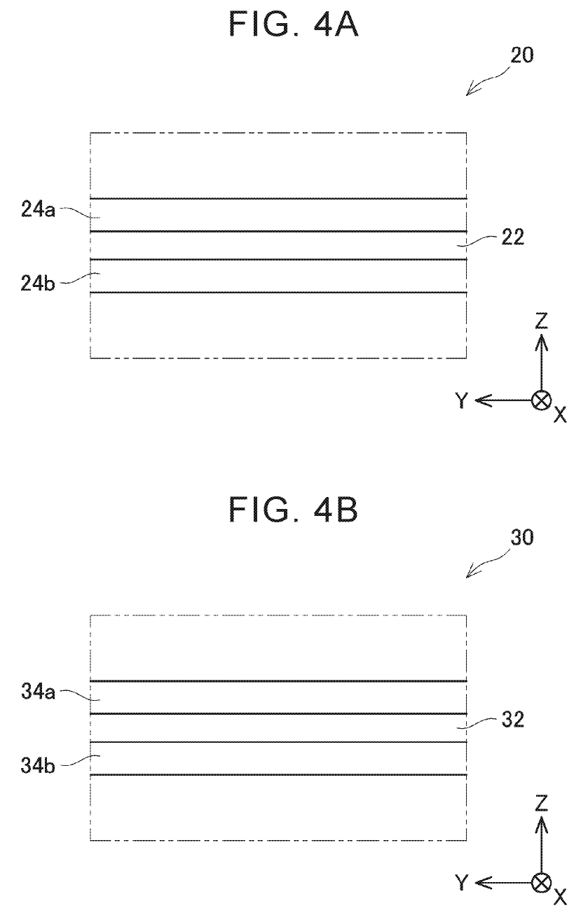

As shown in FIG. 1, the battery 100 further includes a cathode terminal 104 and an anode terminal 106. One end of the cathode terminal 104 is exposed outside the exterior member 102, and the other end of the cathode terminal 104 is connected, inside the exterior member 102, to each cathode current collector foil 22 of the electrode stack 10 (see FIG. 4A). One end of the anode terminal 106 is exposed outside the exterior member 102, and the other end of the anode terminal 106 is connected, inside the exterior member 102, to each anode current collector foil 32 of the electrode stack 10 (see FIG. 4B). The other end of the cathode terminal 104 may be connected to each cathode current collector foil 22 through a corresponding tab formed integrally with that cathode current collector foil 22 or may be connected to each cathode current collector foil 22 through a corresponding tab joined to that cathode current collector foil 22 by welding or another method. Similarly, the other end of the anode terminal 106 may be connected to each anode current collector foil 32 through a corresponding tab formed integrally with that anode current collector foil 32 or may be connected to each anode current collector foil 32 through a corresponding tab joined to that anode current collector foil 32 by welding or another method.

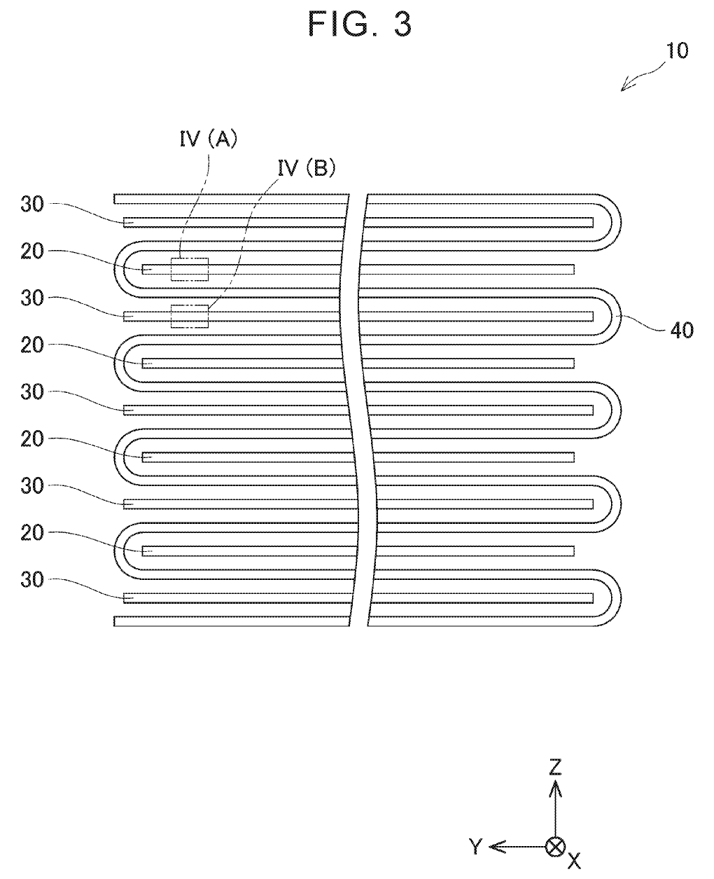

As shown in FIG. 3, the electrode stack 10 includes a plurality of electrode sheets 20, 30 and a separator 40. The electrode sheets 20, 30 are stacked along the Z-direction. The outer edge of each electrode sheet 20, 30 has a rectangular shape defining four corners when viewed along the Z-direction. The electrode sheets 20, 30 include a plurality of cathode sheets 20 and a plurality of anode sheets 30. The separator 40 is an elongated sheet. The separator 40 extends in a zigzag manner between each adjacent pair of cathode and anode sheets 20, 30. That is, the separator 40 is folded at prescribed intervals by alternating mountain folds and valley folds. The cathode sheets 20 and the anode sheets 30 are alternately stacked, with one cathode sheet 20 and one anode sheet 30 disposed between each pair of folded portions of the separator 40. The number of electrode sheets 20, 30 included in the electrode stack 10 is not particularly limited.

As shown in FIG. 4A, each cathode sheet 20 includes a cathode current collector foil 22 and two cathode active material layers 24a, 24b. The outer edge of each of the cathode current collector foil 22 and the cathode active material layers 24a, 24b has a rectangular shape defining four corners when viewed along the Z-direction. The cathode current collector foil 22 is, for example, an aluminum foil. The two cathode active material layers 24a, 24b include an upper cathode active material layer 24a and a lower cathode active material layer 24b. The upper cathode active material layer 24a is provided on one surface (in this example, the surface on the +Z-direction side) of the cathode current collector foil 22 in the Z-direction. The lower cathode active material layer 24b is provided on the other surface (in this example, the surface on the −Z-direction side) of the cathode current collector foil 22 in the Z-direction. The terms "upper" and "lower" in the present specification are used for convenience of description, and do not limit the attitude of the electrode stack 10 during use or manufacturing.

Each of the cathode active material layers 24a, 24b contains a cathode active material. Examples of cathode active materials include lithium nickel composite oxides, lithium cobalt composite oxides, and lithium manganese composite oxides. The cathode active material may be formed of a single material or of multiple materials. Each of the cathode active material layers 24a, 24b may further contain a binder, a conductive additive, etc.

As shown in FIG. 4B, each anode sheet 30 includes an anode current collector foil 32 and two anode active material layers 34a, 34b. The outer edge of each of the anode current collector foil 32 and the anode active material layers 34a, 34b has a rectangular shape defining four corners when viewed along the Z-direction. The anode current collector foil 32 is, for example, a copper foil. The two anode active material layers 34a, 34b include an upper anode active material layer 34a and a lower anode active material layer 34b. The upper anode active material layer 34a is provided on one surface (in this example, the surface on the +Z-direction side) of the anode current collector foil 32 in the Z-direction. The lower anode active material layer 34b is provided on the other surface (in this example, the surface on the −Z-direction side) of the anode current collector foil 32 in the Z-direction. In each of the anode sheets 30, the upper anode active material layer 34a faces, via the separator 40, the lower cathode active material layer 24b of a cathode sheet 20 located immediately above. The lower anode active material layer 34b faces, via the separator 40, the upper cathode active material layer 24a of a cathode sheet 20 located immediately below.

Each of the anode active material layers 34a, 34b contains an anode active material. Examples of anode active materials include carbon materials such as graphite, hard carbon, and soft carbon; materials that form alloys with lithium such as silicon (Si); and lithium alloys. The anode active material may be formed of a single material or of multiple materials. Each of the anode active material layers 34a, 34b may further contain a binder etc.

The separator 40 is configured to allow charge carriers (in this case, lithium ions) to pass therethrough. The separator 40 is formed of a material having insulating properties such as polypropylene or polyethylene. Examples of the separator 40 include porous polyethylene films or porous polypropylene films.

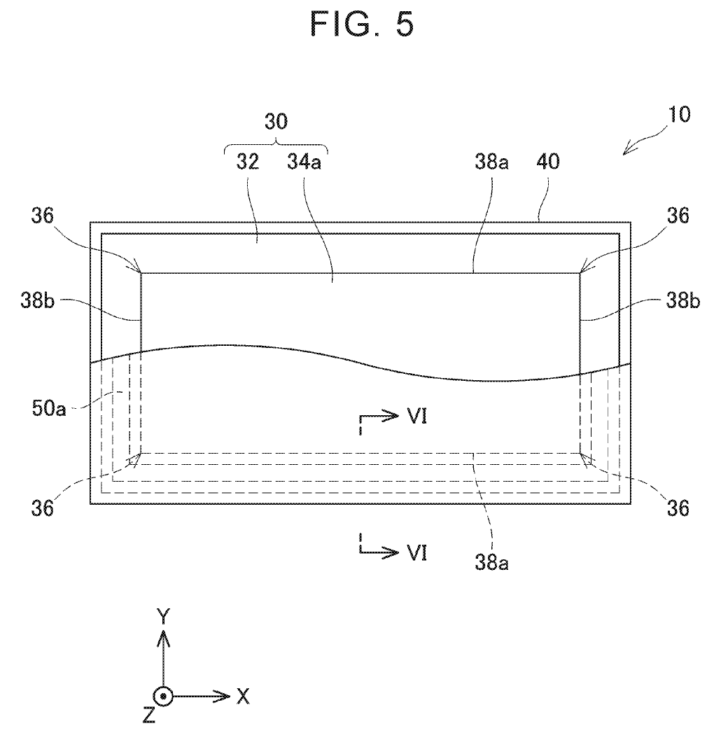

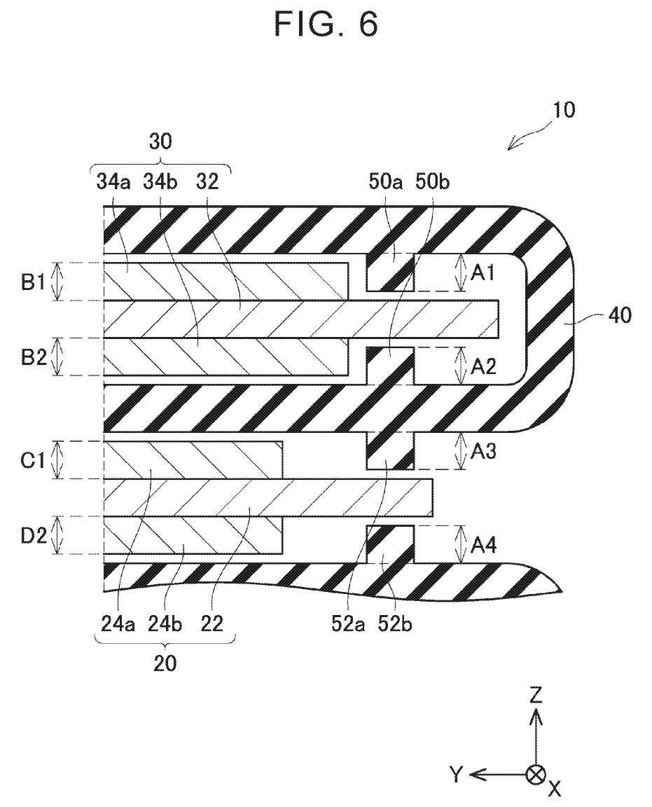

As shown in FIGS. 5 and 6, the electrode stack 10 further includes a plurality of protective members 50a, 50b, 52a, 52b. In the present embodiment, each of the protective members 50a, 50b, 52a, 52b is provided on the separator 40. Each of the protective members 50a, 50b, 52a, 52b is formed of a sheet member made of the same material as the separator 40. That is, each of the protective members 50a, 50b, 52a, 52b is formed of the sheet member provided on the separator 40.

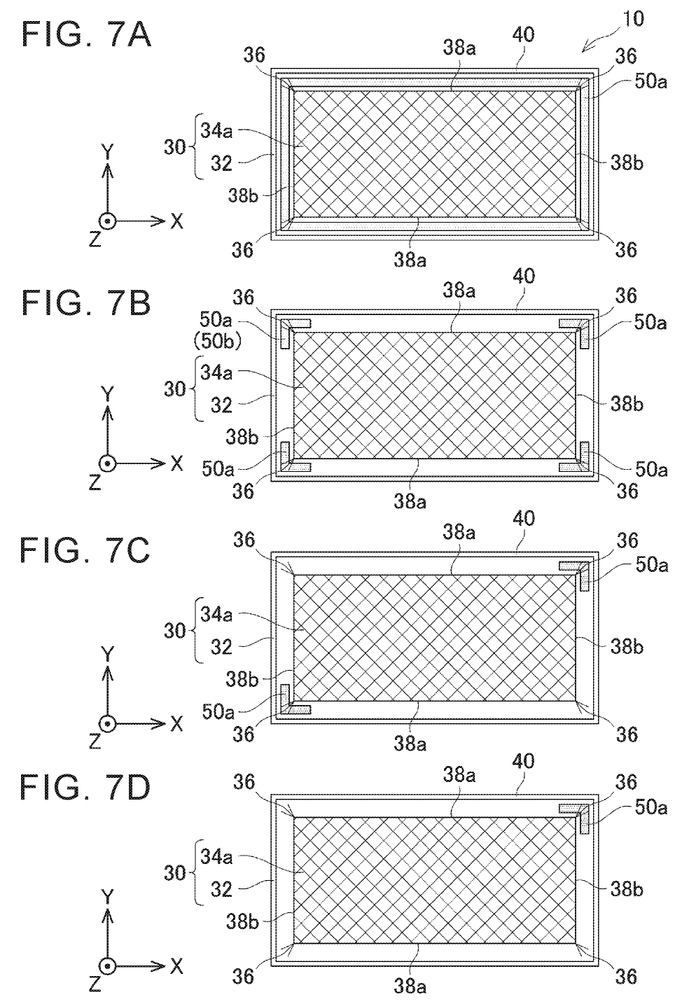

As shown in FIG. 6, the protective members 50a, 50b, 52a, 52b include a first upper protective member 50a, a first lower protective member 50b, a second upper protective member 52a, and a second lower protective member 52b. The first upper protective member 50a is provided to protect other members such as the separator 40 from the upper anode active material layer 34a of an anode sheet 30. As shown in FIG. 7A, the first upper protective member 50a has an annular shape that extends along the entirety of outer edges 38a, 38b of the upper anode active material layer 34a. With such a configuration, over the entirety of the outer edges 38a, 38b of the upper anode active material layer 34a, the first upper protective member 50a is interposed between the upper anode active material layer 34a and another member. As a result, the outer edges 38a, 38b of the upper anode active material layer 34a are less likely to cause damage to another member. In particular, at each of four corners 36 formed in the outer edges 38a, 38b, the first upper protective member 50a extends along two sides 38a, 38b that define the corner 36. With such a configuration, each of the four corners 36 of the upper anode active material layer 34a is less likely to cause damage to another member.

However, the first upper protective member 50a may not have an annular shape. For example, the first upper protective member 50a may have an L-shape. In this case, as shown in FIG. 7B, each of four first upper protective members 50a may be disposed at a corresponding one of the four corners 36 of the upper anode active material layer 34a. As another example, as shown in FIG. 7C, two first upper protective members 50a may be respectively disposed at two diagonally opposing corners 36 of the four corners 36 of the upper anode active material layer 34a. As a further example, as shown in FIG. 7D, one first upper protective member 50a may be disposed at one of the four corners 36 of the upper anode active material layer 34a. In any case, the first upper protective member 50a extends, at at least one corner 36 of the upper anode active material layer 34a, along two sides 38a, 38b that define that corner 36. As a result, since the first upper protective member 50a is interposed between at least one corner 36 of the upper anode active material layer 34a and another member, the other member is protected from at least one corner 36 of the upper anode active material layer 34a.

The first lower protective member 50b is provided to protect other members such as the separator 40 from the lower anode active material layer 34b of a cathode sheet 30. The first lower protective member 50b may have the same configuration as the first upper protective member 50a described above or may have a configuration different from that of the first upper protective member 50a. As one example, the first lower protective member 50b has an annular shape that extends along the entirety of the outer edge of the lower cathode active material layer 24b. That is, the first lower protective member 50b has the same configuration as the first upper protective member 50a shown in FIG. 7A. As another embodiment, the first lower protective member 50b may have another configuration as shown in FIGS. 7B, 7C, or 7D. In this case, the first lower protective member 50b may extend, at at least one corner of the lower anode active material layer 34b, along two sides that define that corner. With this configuration, at least one corner of the lower anode active material layer 34b is less likely to cause damage to another member.

The second upper protective member 52a is provided to protect other members such as the separator 40 from the upper cathode active material layer 24a of a cathode sheet 20. The second upper protective member 52a may have the same configuration as the first upper protective member 50a described above or may have a configuration different from that of the first upper protective member 50a. As one example, in the present embodiment, the second upper protective member 52a has an annular shape that extends along the entirety of the outer edge of the upper cathode active material layer 24a. That is, the second upper protective member 52a has the same configuration as the first upper protective member 50a shown in FIG. 7A. As another embodiment, the second upper protective member 52a may have another configuration as shown in FIGS. 7B, 7C, or 7D. In this case, the second upper protective member 52a may extend, at at least one corner of the upper cathode active material layer 24a, along two sides that define that corner. With this configuration, at least one corner of the upper cathode active material layer 24a is less likely to cause damage to another member.

The second lower protective member 52b is provided to protect other members such as the separator 40 from the lower cathode active material layer 24b of a cathode sheet 20. The second lower protective member 52b may have the same configuration as the first upper protective member 50a described above or may have a configuration different from that of the first upper protective member 50a. As one example, in the present embodiment, the second lower protective member 52b has an annular shape that extends along the entirety of the outer edge of the lower cathode active material layer 24b. That is, the second lower protective member 52b has the same configuration as the first upper protective member 50a shown in FIG. 7A. As another embodiment, the second lower protective member 52b may have another configuration as shown in FIGS. 7B, 7C, or 7D. In this case, the second lower protective member 52b may extend, at at least one corner of the lower cathode active material layer 24b, along two sides that define that corner. With this configuration, at least one corner of the lower cathode active material layer 24b is less likely to cause damage to another member.

As shown in FIG. 6, the size of the cathode sheet 20 is smaller than the size of the anode sheet 30. Accordingly, when viewed along the Z-direction, the outer edge of the cathode sheet 20 is located inward of the outer edge of the anode sheet 30. The sizes of the cathode active material layers 24a, 24b provided on the cathode sheet 20 are also smaller than the sizes of the anode active material layers 34a, 34b provided on the anode sheet 30. Accordingly, when viewed along the Z-direction, the outer edges of the cathode active material layers 24a, 24b are located inward of the outer edges of the anode active material layers 34a, 34b. On the other hand, all of the protective members 50a, 50b, 52a, 52b are formed to have the same size. That is, when viewed along the Z-direction, the positions of all of the protective members 50a, 50b, 52a, 52b coincide with each other. In the cathode sheet 20, the size of the upper cathode active material layer 24a may be the same as or different from the size of the lower cathode active material layer 24b. Similarly, in the anode sheet 30, the size of the upper anode active material layer 34a may be the same as or different from the size of the lower anode active material layer 34b.

As described above, when viewed along the Z-direction, the positions of the outer edges of the two cathode active material layers 24a, 24b are both different from the positions of the outer edges of the anode active material layers 34a, 34b. On the other hand, when viewed along the Z-direction, the position of the first upper protective member 50a coincides with the position of the first lower protective member 50b, the position of the second upper protective member 52a, and the position of the second lower protective member 52b. In other words, all of the protective members 50a, 50b, 52a, 52b are arranged so as to overlap each other along the Z-direction. With such a configuration, unintended bends or wrinkles are less likely to be formed in the current collector foils 22, 32 and/or the separator 40.

As shown in FIG. 6, the thickness of the first upper protective member 50a is designed not to exceed the thickness of the upper cathode active material layer 24a. That is, the dimension A1 of the first upper protective member 50a in the Z-direction is less than or equal to the dimension B1 of the upper cathode active material layer 24a in the Z-direction. With such a configuration, a gap is less likely to be formed between the upper cathode active material layer 24a and the separator 40 in the Z-direction. Similarly, the dimension A2 of the first lower protective member 50b in the Z-direction is less than or equal to the dimension B2 of the lower cathode active material layer 24b in the Z-direction. The dimension A3 of the second upper protective member 52a in the Z-direction is less than or equal to the dimension C1 of the upper anode active material layer 34a in the Z-direction. The dimension A4 of the second lower protective member 52b in the Z-direction is less than or equal to the dimension C2 of the lower anode active material layer 34b in the Z-direction.

In the embodiment described above, two corresponding protective members 50a, 50b, 52a, 52b are provided for each of the electrode sheets 20, 30. Such a configuration more reliably reduces the likelihood that the electrode active material layers 24a, 24b, 34a, 34b cause damage to another member. However, it is sufficient that at least one protective member is provided for at least one of the electrode sheets.

For example, as shown in FIGS. 3 and 6, for the anode sheet 30 located at the upper end in the Z-direction among the electrode sheets 20, 30, there is no cathode sheet 20 facing the upper anode active material layer 34a. Accordingly, the upper anode active material layer 34a of the anode sheet 30 located at the upper end has a higher risk of causing damage to an external member. Therefore, among the electrode sheets 20, 30, at least the upper anode active material layer 34a of the anode sheet 30 located at the upper end may be provided with the first upper protective member 50a. Similarly, for the anode sheet 30 located at the lower end in the Z-direction among the electrode sheets 20, 30, there is no cathode sheet 20 facing the lower anode active material layer 34b. Therefore, among the electrode sheets 20, 30, the second lower protective member 52b may be provided for the lower anode active material layer 34b of at least the anode sheet 30 located at the lower end. Among the electrode sheets 20, 30, the electrode sheets located at the upper end and/or the lower end may be cathode sheets 20.

In the present embodiment, each of the electrode sheets 20, 30 has electrode active material layers 24a, 24b, 34a, 34b on its both surfaces. However, in another embodiment, at least one of the electrode sheets 20, 30 may have a single electrode active material layer on its one surface.

In the embodiment described above, the protective members 50a, 50b, 52a, 52b are formed of sheet members made of the same material as the separator 40. However, the configuration of the protective members 50a, 50b, 52a, 52b is not particularly limited. In another embodiment, the protective members 50a, 50b, 52a, 52b may be formed of a material different from that of the separator 40. For example, the protective members 50a, 50b, 52a, 52b may be formed of a metal material or may be formed of a resin material. Examples of resin materials include materials having insulating properties such as polypropylene and polyethylene. The protective members 50a, 50b, 52a, 52b may be rigid members, or may be flexible members (for example, elastomers or foams). The protective members 50a, 50b, 52a, and 52b may have outer edges that, at the corners 36 of the electrode active material layers 24a, 24b, 34a, 34b, are more rounded than those corners 36. In this way, the protective members 50a, 50b, 52a, 52b can be appropriately designed as long as, in terms of material and/or shape, they are less likely to damage another member than the corners of the electrode active material layers 24a, 24b, 34a, 34b.

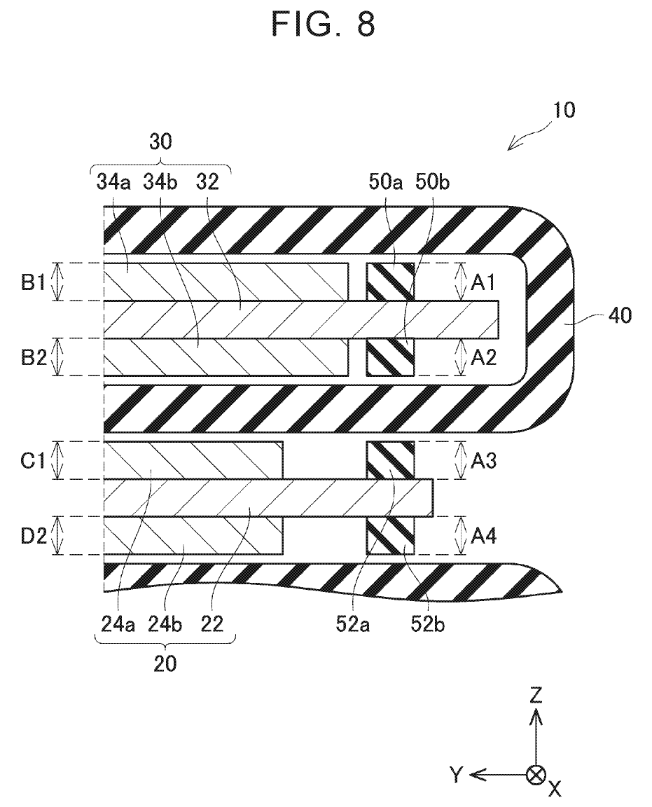

In the embodiment described above, the protective members 50a, 50b, 52a, 52b are provided on the separator 40. However, in another embodiment, as shown in FIG. 8, the protective members 50a, 50b, 52a, 52b may be provided on the current collector foils 22, 32 of the corresponding electrode sheets 20, 30. With such a configuration as well, the protective members 50a, 50b, 52a, 52b can be interposed between the corners 36 of the electrode active material layers 24a, 24b, 34a, 34b and another member.

In the embodiment described above, the outer edge of each of the electrode active material layers 24a, 24b, 34a, 34b has a rectangular shape with four corners 36, when viewed along the Z-axis direction. However, it is sufficient that the outer edge of each of the electrode active material layers 24a, 24b, 34a, 34b has a shape having at least one corner, when viewed in the Z-direction. In this case, at least one protective member may extend, at at least one corner, along two sides that define that corner.

Although some specific examples have been described in detail above, these are merely illustrative and do not limit the scope of the claims. The technology described in the claims includes various modifications and alterations of the specific examples illustrated above. The technical elements described in the present specification or in the drawings exhibit technical utility either individually or in combination.

What is claimed is:

1. An electrode stack comprising:
a plurality of electrode sheets stacked along a first direction; and
a separator that is elongated and extends in a zigzag manner between the electrode sheets, wherein:
each of the electrode sheets includes a current collector foil and an electrode active material layer provided on one surface of the current collector foil;
in at least one of the electrode sheets, at least one protective member that extends along an outer edge of the electrode active material layer is provided on either or both of the electrode sheet and the separator;
the outer edge of the electrode active material layer has a shape having at least one corner; and
each of the at least one protective member extends, at any one of the at least one corner, along two sides that define the corner.

2. The electrode stack according to claim 1, wherein:
the outer edge of the electrode active material layer has a rectangular shape having four corners; and
the at least one protective member includes four protective members respectively disposed at the four corners.

3. The electrode stack according to claim 1, wherein the at least one protective member includes an annular protective member that extends along an entirety of the outer edge of the electrode active material layer.

4. The electrode stack according to claim 1, wherein:
the electrode sheets include a first electrode sheet and a second electrode sheet;
the first electrode sheet includes, as the electrode active material layer, a first electrode active material layer;
the second electrode sheet includes, as the electrode active material layer, a second electrode active material layer that faces the first electrode active material layer via the separator;
at least one first protective member that extends along an outer edge of the first electrode active material layer is provided on either or both of the first electrode sheet and the separator;
at least one second protective member that extends along an outer edge of the second electrode active material layer is provided on either or both of the second electrode sheet and the separator; and
when viewed along the first direction, a position of the outer edge of the first electrode active material layer is different from a position of the outer edge of the second electrode active material layer, while a position of the at least one first protective member coincides with a position of the at least one second protective member.

5. The electrode stack according to claim 1, wherein the at least one protective member is provided for the electrode active material layer of at least the electrode sheet that is located at one end in the first direction among the electrode sheets.

6. The electrode stack according to claim 1, wherein the at least one protective member is provided for each of the electrode sheets.

7. The electrode stack according to claim 1, wherein the at least one protective member is formed of a sheet member made of the same material as the separator.

8. The electrode stack according to claim 1, wherein the at least one protective member is formed of a member different from the separator.

9. The electrode stack according to claim 1, wherein a dimension of the at least one protective member in the first direction is less than or equal to a dimension, in the first direction, of the electrode active material layer provided on the at least one of the electrode sheet.
